(19) United States
(12) Patent Application Publication
(10) Pub. No.: US 2025/0139349 A1
(43) Pub. Date: May 1, 2025

(54) MULTI-DIE INTEGRATED PACKAGE DESIGN METHOD AND SYSTEM USING THE SAME

(71) Applicant: INDUSTRIAL TECHNOLOGY RESEARCH INSTITUTE, Hsinchu (TW)

(72) Inventors: Chien-Min HSU, Zhubei City (TW); Chang-Tzu LIN, Zhubei City (TW); Shih-Hsien WU, Taoyuan City (TW)

(73) Assignee: INDUSTRIAL TECHNOLOGY RESEARCH INSTITUTE, Hsinchu (TW)

(21) Appl. No.: 18/399,154

(22) Filed: Dec. 28, 2023

(30) Foreign Application Priority Data
Nov. 1, 2023 (TW) 112142044

(51) Int. Cl. G06F 30/398; G06F 30/31

(52) U.S. Cl. CPC G06F 30/398; G06F 30/31

(57) ABSTRACT

A multi-chip integrated package design system includes a model analysis, a 3D model analysis and an electrical simulation. The model analysis obtains a pin connection mode of the designed circuit according to a designed circuit, obtains at least one conductive layer of the designed circuit according to a layer stackup, selects a transmission line model that meets the pin connection mode and at least one conductive layer, substitutes the layer stackup and a design rule into the selected transmission line model to generate an equivalent circuit, generates a corresponding relationship according to the equivalent circuit, and obtains the transmission line length corresponding to a parameter design target according to the corresponding relationship. The 3D model analysis constructs a 3D model of the designed circuit according to the obtained the transmission line length. The electrical simulation determines whether the characteristic parameter of the 3D model meets the parameter design target.

This application claims the benefit of Taiwan application Serial No. 112142044, filed Nov. 1, 2023, the disclosure of which is incorporated by reference herein in its entirety.

### TECHNICAL FIELD

The disclosure relates to a multi-chip integrated package design method and a multi-chip integrated package design system method using the same.

### BACKGROUND

The conventional packaging design process is that the layout engineer performs a circuit layout according to the design rules, then the electrical engineer conducts the packaging circuit design simulation analysis (such as the commercial design tool software Cadence/Ansys) according to experience, and then performs functional verification. If the verification is successful, process ends. If the verification fails, the previous steps are repeated. However, manual adjustment exists some problems such as misjudgment, time-consuming, etc. Therefore, how to improve the aforementioned conventional problems is one of the goals of those in this technical field.

### SUMMARY

According to an embodiment, a multi-chip integrated package design method is provided. The multi-chip integrated package design method includes the following steps: obtaining a schematic of a design circuit; performing a circuit layout according to the schematic of the design circuit; constructing a three-dimensional (3D) model of the circuit layout; determining whether a characteristic parameter of the 3D model meets a characteristic parameter design target; select a patent document that meets the circuit layout from a patent database when the characteristic parameter does not meet the characteristic parameter design target; and optimizing the design circuit according to the patent document. Performing the circuit layout according to the schematic of the design circuit includes: obtaining a pin connection mode of the design circuit according to the schematic of the design circuit; obtaining at least one conductive layer of the design circuit according to the layer stackup; selecting a transmission line model that meets the pin connection mode and the at least one conductive layer from a plurality of the transmission line models in a transmission line model database; substituting the layer stackup and a design rule into an equivalent circuit corresponding to the selected transmission line model; generating a corresponding relationship of a transmission line length and characteristic parameter according to the equivalent circuit; obtaining the transmission line length corresponding to the characteristic parameter design target according to the corresponding relationship of the transmission line length and characteristic parameter, wherein the transmission line length is used as a design constraint for the circuit layout. Constructing the 3D model of the circuit layout includes: performing the circuit layout of the design circuit according to the obtained the transmission line length used as a design constraint and constructing the 3D model of the circuit layout.

According to another embodiment, a multi-chip integrated packaging design system is provided. The multi-chip integrated packaging design system includes a model analysis, a 3D model analysis and an electrical simulation. The model analysis is configured to obtain a schematic of a design circuit; and performing a circuit layout according to the schematic of the design circuit. The 3D model analysis is configured to construct the 3D model of the circuit layout. The electrical simulation is configured to determine whether a characteristic parameter of the 3D model meets a characteristic parameter design target; select a patent document that meets the circuit layout from a patent database when the characteristic parameter does not meet the characteristic parameter design target; and optimize the design circuit according to the patent document. The model analysis is further configured to obtain a pin connection mode of the design circuit according to the schematic of the design circuit; obtain at least one conductive layer of the design circuit according to the layer stackup; select a transmission line model that meets the pin connection mode and the at least one conductive layer from a plurality of the transmission line models in a transmission line model database; substitute the layer stackup and a design rule into the selected transmission line model to generate an equivalent circuit; generate a corresponding relationship of a transmission line length and characteristic parameter according to the equivalent circuit; and obtain the transmission line length corresponding to the characteristic parameter design target according to the corresponding relationship of the transmission line length and characteristic parameter, wherein the transmission line length is used as a design constraint for the circuit layout. The 3D model analysis is further configured to perform the circuit layout of the design circuit according to the obtained the transmission line length used as the design constraint and construct the 3D model of the circuit layout.

### BRIEF DESCRIPTION OF THE DRAWINGS

FIG. 1 illustrates a functional block diagram of a multi-chip integrated package design system according to an embodiment of the disclosure;

FIG. 2 illustrates a schematic diagram of a partial schematic of a design circuit according to an embodiment of the disclosure;

FIG. 3 illustrates a schematic diagram of cross-sectional views of a plurality of transmission line models in a transmission line model database in FIG. 1;

FIG. 4 illustrates a schematic diagram of an equivalent circuit of the transmission line model meets a pin connection mode and at least one conductive layer in FIG. 1;

FIG. 5 illustrates a schematic diagram of a partial cross-sectional view of a semiconductor package structure of the design circuit according to an embodiment of the disclosure;

FIG. 6 illustrates a schematic diagram of a S21 parameter curve of the insertion loss of the equivalent circuit in FIG. 4;

FIG. 7 illustrates a schematic diagram of a corresponding relationship SR1 between a transmission line length and a characteristic parameter VL (voltage amplitude loss) of the equivalent circuit in FIG. 4;

FIG. 8 illustrates a schematic diagram of a partial elevation view of a

3D model constructed according to the obtained transmission line length and a layer stackup;

FIG. 9 illustrates a flow chart of a package design method of the multi-chip integrated package design system in FIG. 1;

FIG. 10 illustrates a schematic diagram of the technology/efficiency/target matrix according to an embodiment of the disclosure;

FIG. 11 illustrates a schematic diagram of a corresponding relationship SR2 between a transmission line length and a characteristic parameter IL (insertion loss) of the equivalent circuit in FIG. 4;

FIG. 12 illustrates a schematic diagram of a S11 parameter curve of the return loss of the equivalent circuit EC in FIG. 4;

FIG. 13 illustrates a corresponding relationship SR3 between a transmission line length and a characteristic parameter RL (return loss) of the equivalent circuit EC in FIG. 4;

FIG. 14 illustrates a schematic diagram of the characteristic parameters Zo (characteristic impedance) of the 3D model in FIG. 8;

FIG. 15 illustrates a schematic diagram of the technology/efficiency/target matrix according to another embodiment of the disclosure; and

FIG. 16 illustrates a part of the top view of the improved 3D model M1 in FIG. 8.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

The invention proposes a multi-chip integrated package design method and a multi-chip integrated package design system using the same, which are suitable for a systematic packaging design method of multi-chip integrated connection in the vertical direction or horizontal direction. The universal integrated connection design and optimized electrical methods are completed by inputting chip information and process design rules through such integrated package design method.

The disclosure applies the packaging design method to transmission line model database and the patent database, and is suitable for multi-chip integrated packaging in both horizontal and vertical directions.

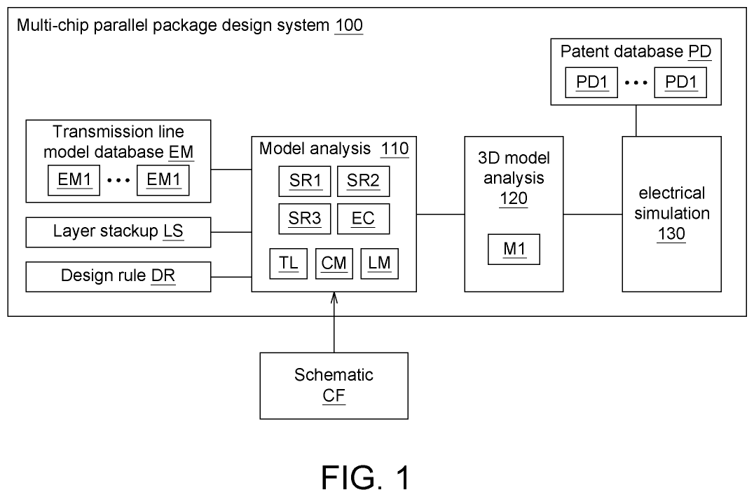

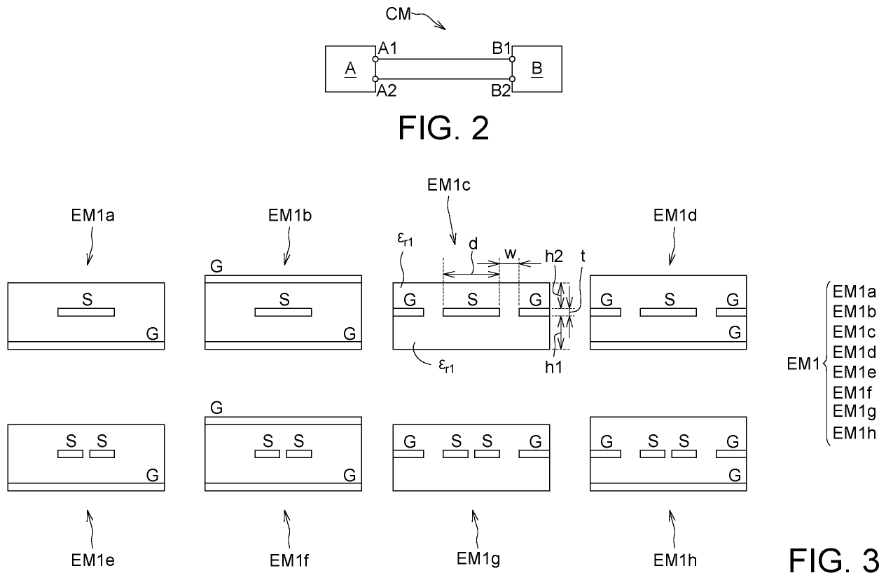

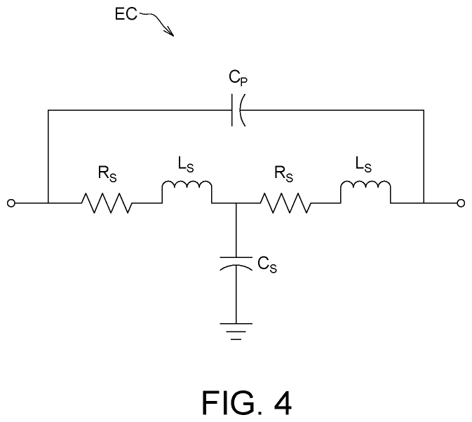

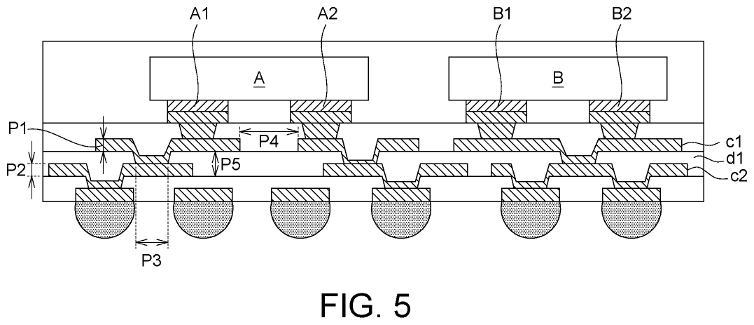

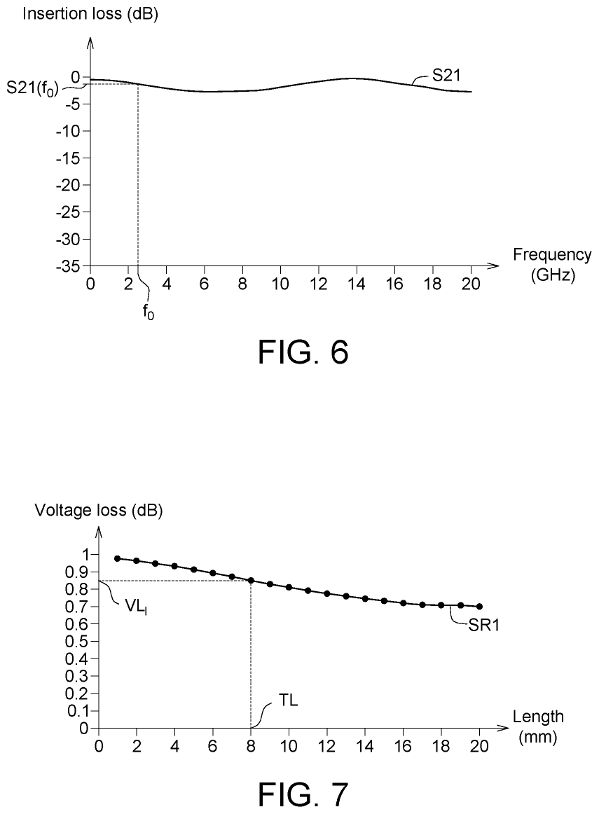

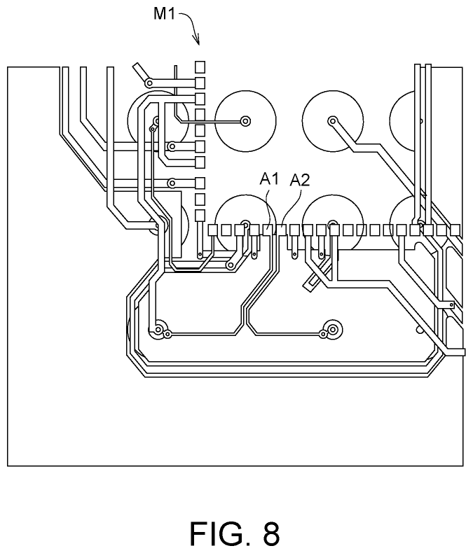

Referring to FIGS. 1 to 8, FIG. 1 illustrates a functional block diagram of a multi-chip integrated package design system 100 according to an embodiment of the disclosure, FIG. 2 illustrates a schematic diagram of a partial schematic CF of a design circuit according to an embodiment of the disclosure, FIG. 3 illustrates a schematic diagram of a plurality of transmission line models EM1 in a transmission line model database EM in FIG. 1, FIG. 4 illustrates a schematic diagram of an equivalent circuit EC of the transmission line model EM1c meeting a pin connection mode CM and at least one conductive layer LM in FIG. 1, FIG. 5 illustrates a schematic diagram of a partial cross-sectional view of a semiconductor package structure of the design circuit according to an embodiment of the disclosure, FIG. 6 illustrates a schematic diagram of a S21 parameter curve of an insertion loss S21 of the equivalent circuit EC in FIG. 4, FIG. 7 illustrates a schematic diagram of a corresponding relationship SR1 between a transmission line length and a characteristic parameter VL (voltage amplitude loss) of the equivalent circuit EC in FIG. 4, and FIG. 8 illustrates a schematic diagram of a partial elevation view of a three-dimensional (3D) model M1 constructed according to the obtained transmission line length TL and a layer stackup LS.

As illustrated in FIG. 1, the multi-chip integrated package design system 100 includes a model analysis 110, a 3D model analysis 120, an electrical simulation 130, the transmission line model database EM, the layer stackup LS, a design rule DR and a patent database PD. The transmission line model database EM stores a plurality of transmission line models EM1. The patent database PD stores a plurality of patent documents PD1. In addition, the transmission line model database EM, the layer stackup LS and/or the design rule DR may be stored in the multi-chip integrated package design system 100 in advance. For example, the transmission line model database EM, the layer stackup LS and/or the design rule DR may be stored in a memory (not shown) of the multi-chip integrated package design system 100 or in the model analysis 110. In addition, the model analysis 110, the 3D model analysis 120 and/or the electrical simulation 130 is, for example, a physical circuit, such as a semiconductor wafer, a semiconductor package, etc., formed by at least one semiconductor process. At least two of the model analysis 110, the 3D model analysis 120 and the electrical simulation 130 may be integrated into single unit, or the model analysis 110, the 3D model analysis 120 and/or the electrical simulation 130 may be integrated into a controller or a processor.

The model analysis 110 is configured to obtain the schematic CF of the design circuit and perform a circuit layout according to the schematic CF of the design circuit. The 3D model analysis 120 is configured to construct a 3D model M1 of the design circuit according to the circuit layout. The electrical simulation 130 is configured to determine whether a characteristic parameter of the 3D model M1 meet a characteristic parameter design target. When the characteristic parameter does not meet the characteristic parameter design target, a patent document that meet the circuit layout is selected from the patent database PD; and, optimize the design circuit according to the patent document.

Furthermore, as illustrated in FIG. 1, the model analysis 110 is configured to obtain the pin connection mode of the design circuit according to the schematic CF of the design circuit (for example, the schematic CF is illustrated in FIG. 2); obtain at least one conductive layer LM of the design circuit according to the layer stackup LS (table 1 below); select the transmission line model EM1 meeting the pin connection mode CM and the at least one conductive layer LM form the transmission line models EM1 (the transmission line models EM1 are illustrated in FIG. 3); substitute the layer stackup LS and the design rule DR into the selected transmission line model EM1 to generate the corresponding equivalent circuit EC; generate the corresponding relationship SR1 between the transmission line length and the characteristic parameters (For example, the corresponding relationship SR1 is illustrated in FIG. 7) according to the equivalent circuit EC; and obtain the transmission line length TL (for example, the transmission line length TL is illustrated in FIG. 7) corresponding to a characteristic parameter design target according to the corresponding relationship SR1 between the transmission line length and the characteristic parameter, wherein the transmission line length TL may be used as a design constraint for the circuit layout. The 3D model analysis 120 is configured to perform the circuit layout of the design circuit according to the obtained transmission line length TL as the design constraint, and construct the 3D model M1 of the design circuit (for example, the 3D model M1 is illustrated in FIG. 8). The electrical simulation 130 is configured to obtain that the characteristic parameter of the 3D model M1 meeting the characteristic parameter design target; and when the characteristic parameter of the 3D model M1 does not meet the characteristic parameter design target, select the patent documents PD1 meeting the characteristic parameter design target from the patent database PD and place the structure disclosed in the patent document PD1 into the 3D model M1 of the circuit layout by using a technology/efficiency/target matrix. As a result, the multi-chip integrated package design system 100 selects the patent document that meet the characteristic parameter design target from the patent database PD according to the schematic information (if the characteristic parameter of the 3D model M1 do not meet the characteristic parameter design target). The patent document PD1 is, for example, a patent number, such as a patent number, a publication number, an application number, etc.

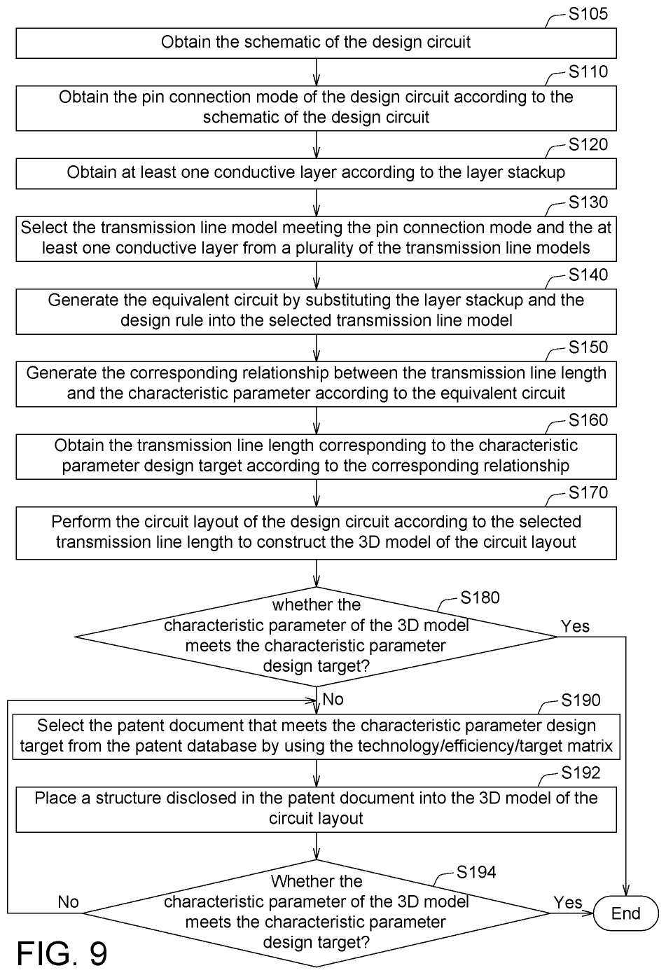

Referring to FIG. 9, FIG. 9 illustrates a flow chart of a package design method of the multi-chip integrated package design system 100 in FIG. 1.

In step S105, the model analysis 110 obtains the schematic CF of the design circuit (as illustrated in FIG. 2).

Then, the model analysis 110 may perform circuit layout according to the schematic of the design circuit. The circuit layout includes, for example, the following steps S110 to S160.

In step S110, the model analysis 110 may obtain the pin connection mode CM of the design circuit according to the schematic CF of the design circuit (as illustrated in FIG. 2). In an embodiment, the model analysis 110 may obtain the pin connection mode CM by analyzing the schematic CF, or manually input the pin connection mode CM into the model analysis 110.

Furthermore, as illustrated in FIG. 2, the schematic CF is a connection mode of component A and component B. The component A includes at least two pins A1 and A2, the component B includes at least two pins B1 and B2, wherein the pin A1 is electrically connected to the pin B1, and pin A2 is electrically connected to the pin B2. Accordingly, the pin connection mode CM of the component A and the component B is a “2-to-2” connection mode. The component A and the component B are, for example, chips. The component A and the component B may be disposed horizontally or stacked vertically. In another embodiment, the number of components is not limited to two, but may also be three or more.

In step S120, the model analysis 110 obtains the at least one conductive layer LM of the design circuit according to the layer stackup LS. The layer stackup LS displays the information of each layer of the semiconductor package structure corresponding to the design circuit, such as layer thickness, material and material parameter (for example, conductivity and/or dielectric constant, loss tangent, etc.). In an embodiment, the model analysis 110 may obtain the at least one conductive layer LM by analyzing the layer stackup LS, or manually input the at least one conductive layer LM into the model analysis 110.

As shown in Table 1 below, the layer stackup LS lists the layer thickness, the material and the conductivity of each conductive layer of the design circuit, as well as the thickness, the material and the material parameter (for example, dielectric constant and conductivity) of each layer. The model analysis 110 obtain the at least one conductive layer of the design circuit is 2 from Table 1.

TABLE 1
(layer stackup LS)

| | | Thickness | dielectric | conductivity |
|---|---|---|---|---|
| | material | (micrometer, μm) | constant DK | (S/m) |
| conductive | copper | 4 | — | 5.8 × 10⁷ |
| layer c1 | | | | |
| dielectric | polyimide | 10 | 3.2 | — |
| layer d1 | | | | |
| conductive | copper | 4 | — | 5.8 × 10⁷ |
| layer c2 | | | | |

In step S130, the model analysis 110 selects the transmission line model EM1 that meets the pin connection mode CM and the at least one conductive layer LM from a plurality of the transmission line models EM1 in the transmission line model database EM in FIG. 3.

As illustrated in FIG. 3, the transmission line model database EM includes at least one conductive layer (the same horizontal layer is the same conductive layer), and one of the at least one conductive layer includes at least one signal line pin S and/or at least one ground line pin G (optional). For example, the number of at least one conductive layer LM of the transmission line model EM1a is 2, and the pin connection mode CM is 1-to-1; the number of at least one conductive layer LM of the transmission line model EM1b is 3, and the pin connection mode CM is 1-to-1; the number of at least one conductive layer LM of the transmission line model EM1c is 1, and the pin connection mode CM is 1-to-1; the number of at least one conductive layer LM of the transmission line model EM1d is 2, and the pin connection mode CM is 1-to-1; the number of at least one conductive layer LM of the transmission line model EM1e is 2, and the pin connection mode CM is 2-to-2; the number of at least one conductive layer LM of the transmission line model EM1f is 3, and the pin connection mode CM is 2-to-2; the number of at least one conductive layer LM of the transmission line model EM1g is 1, and the pin connection mode CM is 2-to-2; the number of at least one conductive layer LM of the transmission line model EM1h is 2, and the pin connection mode CM is 2-to-2.

The model analysis 110 may obtain the information that the pin connection mode CM is 2-to-2 and the number of at least one conductive layer LM is 2 from the first two steps S110 to S120, and perform a simulation for two connected transmission line models EM1e or two connected transmission line models EM1h.

In step S140, the model analysis 110 generates an equivalent circuit EC as illustrated in FIG. 4 by substituting the layer stackup LS and the design rule DR into the selected transmission line model EM1e.

As shown in Table 2 below, the design rule DR shows the design rules (or design constraints) such as a transmission line width, a transmission line spacing, a transmission line thickness, a pad spacing, a conductive via diameter, and a dielectric layer thickness of the semiconductor package structure corresponding to the design circuit. As shown in Table 2 and FIG. 5, the symbols P1 to P2 in Table 2 indicate the semiconductor package structure of the design circuit in FIG. 5.

TABLE 2
(design rule DR)

| Symbol | Design Parameter | Design Rule | |
|---|---|---|---|
| P1 | minimum line width/minimum line | 10/10/3 | (μm) |
| | spacing/wire thickness (conductive layer | | |
| | c1) | | |
| P2 | minimum line width/minimum line | 8/8/3 | (μm) |
| | spacing/wire thickness (conductive layer | | |
| | c2) 8/8/3 (μm) | | |
| P3 | minimum conductive via diameter | 5 | (μm) |
| | between conductive layers 1 and 2 | | |
| P4 | minimum distance between two pads | 20 | (μm) |
| P5 | thickness of dielectric layer d1 | 10 | (μm) |

As shown in FIG. 4, the equivalent circuit EC includes at least one impedance, such as capacitors C_{P}, C_{S}, an inductor L_{S} and/or a resistor R_{S}. The values of the capacitors C_{P}, C_{S}, the inductor L_{S} and/or the resistor R_{S} may depend on the specifications of the design rule DR, and are not limited in the embodiment of the disclosure. FIG. 4 takes a 1-to-1 equivalent circuit as an example to illustrate that two 1-to-1 equivalent circuits may be connected to form a 2-to-2 equivalent circuit. The capacitance C_{P}, C_{S}, the inductor L_{S} and resistor R_{S} in FIG. 4 may be obtained according to the following formulas (A) to (D2).

$${C}_{p} = \frac{t}{2 π * {Z}_{0}} = \frac{Length / {V}_{ph}}{2 π * {Z}_{0}} = \frac{Length * \sqrt{{ε}_{eff}}}{2 π * C * {Z}_{0}} \qquad ( A )$$

$${ε}_{eff} = \frac{{C}_{CPW}}{{C}_{air}} \qquad ( A1 )$$

$${Z}_{0} = \frac{1}{C * {C}_{air} \sqrt{{ε}_{eff}}} \qquad ( A2 )$$

$${C}_{cpw} = {C}_{1} + {C}_{2} + {C}_{air} \qquad ( A3 )$$

$${C}_{1} = 2 {ε}_{0} ( {ε}_{r 1} - 1 ) \frac{K ( {k}_{1} )}{K ( {k}_{1}^{′} )} \qquad ( A4 )$$

$${C}_{2} = 2 {ε}_{0} ( {ε}_{r 2} - 1 ) \frac{K ( {k}_{2} )}{K ( {k}_{2}^{′} )} \qquad ( A5 )$$

$${k}_{1} = \frac{sinh ( π w / 4 {h}_{1} )}{sinh \{ [ π ( w + 2 d ) ] / 4 {h}_{1} ]} \qquad ( A6 )$$

$${k}_{1}^{′} = \sqrt{1 - {k}_{1}^{2}} \qquad ( A7 )$$

$${k}_{2} = \frac{sinh ( π w / 4 {h}_{2} )}{sinh \{ [ π ( w + 2 d ) ] / 4 {h}_{2} \}} \qquad ( A8 )$$

$${k}_{2}^{′} = \sqrt{1 - {k}_{2}^{2}} \qquad ( A9 )$$

$${C}_{air} = 2 {ε}_{0} \frac{K ( {k}_{3} )}{K ( {k}_{3}^{′} )} + 2 {ε}_{0} \frac{K ( {k}_{4} )}{K ( {k}_{4}^{′} )} \qquad ( A10 )$$

$${K}_{3} = \frac{tanh ( π w / 4 {h}_{3} )}{tanh \{ [ π ( w + 2 d ) ] / 4 {h}_{3} \}} \qquad ( A11 )$$

$${K}_{4} = \frac{tanh ( π w / 4 {h}_{4} )}{tanh \{ [ π ( w + 2 d ) ] / 4 {h}_{4} \}} \qquad ( A12 )$$

$${k}_{3}^{′} = \sqrt{1 - {k}_{3}^{2}} \qquad ( A13 )$$

$${k}_{4}^{′} = \sqrt{1 - {k}_{4}^{2}} \qquad ( A14 )$$

$${C}_{p} = \frac{t}{2 π * {Z}_{0}} = \frac{length / {V}_{ph}}{2 π * {Z}_{0}} = \frac{length * \sqrt{{ε}_{eff}}}{2 π * C * {Z}_{0}} \qquad ( B )$$

$${ε}_{eff} = \frac{{C}_{CPW}}{{C}_{air}} \qquad ( B1 )$$

$${Z}_{0} = \frac{1}{C * {C}_{air} \sqrt{{ε}_{eff}}} \qquad ( B2 )$$

$${R}_{s} = R / 2 \qquad ( C )$$

$$R = ρ \frac{length}{d * t} \qquad ( C1 )$$

$${L}_{s} = \frac{L - 2 * {L}_{m}}{2} \qquad ( D )$$

$${L}_{m} = \frac{μ}{4 π} * ( - ( \frac{length}{2} ) * log ( \frac{length}{2} ) + length * log ( length ) - ( \frac{length}{2} ) \times log ( \frac{length}{2} ) ) \qquad ( D1 )$$

$$L = {C}_{s} * {Z}_{o}^{2} \qquad ( D2 )$$

In the formula, as shown in the transmission line model EM1c in FIG. 3, K(k₁) and K (k₁′) are complete elliptic integrals. h1 is the thickness of the lower dielectric layer. εᵣ₁ is the dielectric constant of the lower dielectric layer. h2 is the thickness of the upper dielectric layer. εᵣ₂ is the dielectric constant of the upper dielectric layer. “length” is the length of the transmission line. ρ is the resistivity of the transmission line material. t is the thickness of the transmission line. R is the resistance value of the transmission line. C is the speed of light 3×10⁸ m/s. h3 is the distance between the conductor (as a shielding, not shown) above the transmission line model EM1c in FIG. 3 and the coplanar waveguide structure. h4 is the distance between the conductor (as a shielding, not shown) below the transmission line model EM1c in FIG. 3 and the coplanar waveguide structure. d is the transmission line width, and w is the slot width.

Conformal mapping technology is used to calculate the equivalent dielectric constant ε_{eff} and characteristic impedance Zo. Therefore, it is assumed that the conductor thickness t=0 and the magnetic field wall appears along the dielectric boundary condition including the slot. Assuming that the electric field exists in local areas, the coplanar waveguide structure may be split into three blocks for analysis, separated by dielectric materials, including a coplanar waveguide with a first dielectric constant εᵣ₁, a coplanar waveguide with a second dielectric constant εᵣ₂ and a coplanar waveguide with vacuum materials (εᵣ=1) above and below. The aforementioned three blocks each form the capacitance values C₁, C₂ and Cₐᵢᵣ, and the total capacitance value of the coplanar waveguide structure is equal to the sum of the capacitance values of the three blocks.

In step S150, referring to FIGS. 4 to 6, in this step, the model analysis 110 generates the corresponding relationship SR1 between the transmission line length and the characteristic parameter according to the equivalent circuit EC.

In the present embodiment, the characteristic parameter VL is “voltage amplitude loss”, for example.

For example, the model analysis 110 may obtain the characteristic parameter VL (voltage amplitude loss) of different numbers n of the equivalent circuits EC connected in series to build the corresponding relationship SR1. The value of n is a positive integer equal to or greater than 1, and the embodiment of the disclosure does not limit the upper limit of n. Taking one (n=1) equivalent circuit EC as an example, the model analysis 110 may obtain a S21 parameter curve of the insertion loss (shown in FIG. 6) of the equivalent circuit EC, and obtain the parameter value (that is, S21 (f₀)) of the S21 parameter curve corresponding to an input frequency f₀ (for example, 2.4 GHZ) from the S21 parameter curve, and obtain the corresponding characteristic parameter VL according to following formula (1). According to this principle, the model analysis 110 may obtain the characteristic parameter VL of n equivalent circuits EC connected in series (for each additional equivalent circuit EC, one corresponding characteristic parameter VL may be obtained), and create the corresponding relationship SR1 between the transmission line length and the characteristic parameter VL (voltage amplitude loss) as shown in FIG. 7. As shown in FIG. 7, the abscissa is the transmission line length of n equivalent circuits EC connected in series, and its unit is millimeters (mm). The ordinate of FIG. 7 is the voltage amplitude loss (VL).

$$VL = {10}^{\frac{S 21 ( {f}_{0} )}{20}} \qquad ( 1 )$$

In step S160, the model analysis 110 may obtain the transmission line length TL corresponding to the characteristic parameter design target VL_{I} according to the corresponding relationship SR1, wherein such transmission line length TL may be used as a design constraint for the circuit layout. For example, as illustrated in FIG. 7, the characteristic parameter design target VL_{I} is 0.85 volt (V). For example, the allowable voltage amplitude loss reduces to 0.85 V from 1 V, and the corresponding transmission line length TL corresponding to 0.85 V is 8 millimeters (mm). In other words, the transmission line length on the conductive layer of the design circuit is not greater than 8 mm to prevent the voltage at the end of the transmission line from being less than 0.85 V.

In step S170, as illustrated in FIG. 8, after obtaining the transmission line length TL, the 3D model analysis 120 may perform the circuit layout of the design circuit according to the transmission line length TL and the layer stackup LS, and construct the 3D model M1 of the design circuit (i.e., 3D model of the semiconductor package structure).

In step S180, the electrical simulation 130 determines whether the characteristic parameter VL of the 3D model M1 meets the characteristic parameter design target VL_{I}. For example, after constructing the 3D model M1, the electrical simulation 130 may analyze the 3D model M1 to obtain the characteristic parameters VL of the 3D model M1 by using appropriate analysis techniques. The aforementioned analysis technology is, for example, the electronic design automation (EDA), for example, EDA software developed by Ansys or Cadence.

If the characteristic parameter VL meets the characteristic parameter design target VL_{I}, the process ends. If the characteristic parameter VL does not meet the characteristic parameter design target VL_{I}, the process proceeds to step S190 to search for a solution (improvement) from the transmission line model database EM (patent document).

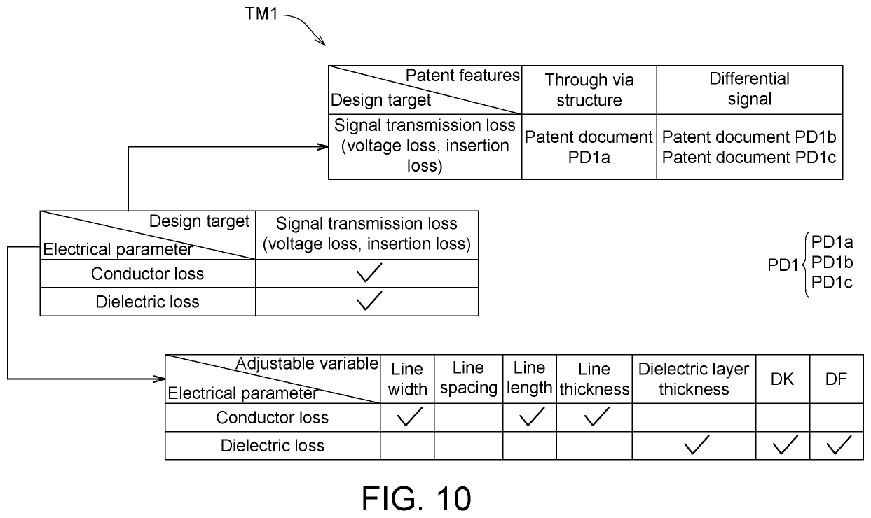

In step S190, referring to FIG. 10, FIG. 10 illustrates a schematic diagram of the technology/efficiency/target matrix TM1 according to an embodiment of the disclosure. The electrical simulation 130 selects the patent document from the patent database PD that may satisfy with “the characteristic parameters of the 3D model M1 meets the characteristic parameter design target VL_{I}” by using the technology/efficiency/target matrix.

Then, the circuit may be optimized and design circuit according to the patent document.

For example, as illustrated in FIG. 10, the technology/efficiency/target matrix TM1 lists the relationships among technology, efficacy, design target and corresponding patent documents (for example, the patent number). it may be seen from the technology/efficiency/target matrix TM1 that the reduction of voltage amplitude loss is related to the adjustment of conductor loss and dielectric loss, wherein the conductor loss is related to the transmission line width, transmission line length and the transmission line thickness, and the dielectric loss is related to the dielectric layer thickness, the dielectric constant DK of the dielectric layer and the loss tangent DF of the dielectric layer. The patent document related to this information is a patent document PD1a. According to the patent document PD1a, a ground island structure may be used to satisfy with “the characteristic parameters of the 3D model M1 meets the characteristic parameter design target VL_{I}”.

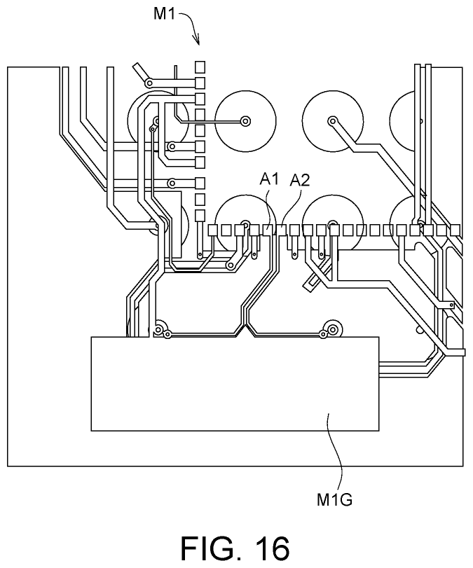

In step S192, the 3D model analysis 120 constructs the corresponding 3D model M1. The multi-chip integrated package design method places a structure disclosed in the patent document into the 3D model of the circuit layout. For example, the 3D model analysis 120 updates (or modifies) the 3D model M1 according to the improvement technical solution in the selected patent document. For specific ways to update (or modify) the 3D model M1, referring to FIG. 16 and its related description stated later.

In step S194, the electrical simulation 130 determines whether the characteristic parameter VL (voltage amplitude loss) of the updated (or modified) 3D model M1 meets the characteristic parameter design target VL_{I}. For example, after updating (or modified) the 3D model M1, the electrical simulation 130 may obtain the characteristic parameter VL of the updated (or modified) 3D model M1 by using, for example, the aforementioned EDA analysis technology.

If the characteristic parameter VL of the updated (or modified) 3D model M1 meets the characteristic parameter design target VL_{I}, the process ends. If the characteristic parameter of the updated 3D model M1 does not meet the characteristic parameter design target VL_{I}, the process returns to step S190 to search for another solution from the patented technology again.

The following describes a flow chart of the second package design method of the multi-chip integrated package design system 100. The packaging design method of the present embodiment includes processes similar to that described above. The different steps between the two will be described below, and similar or identical steps will not be repeated here.

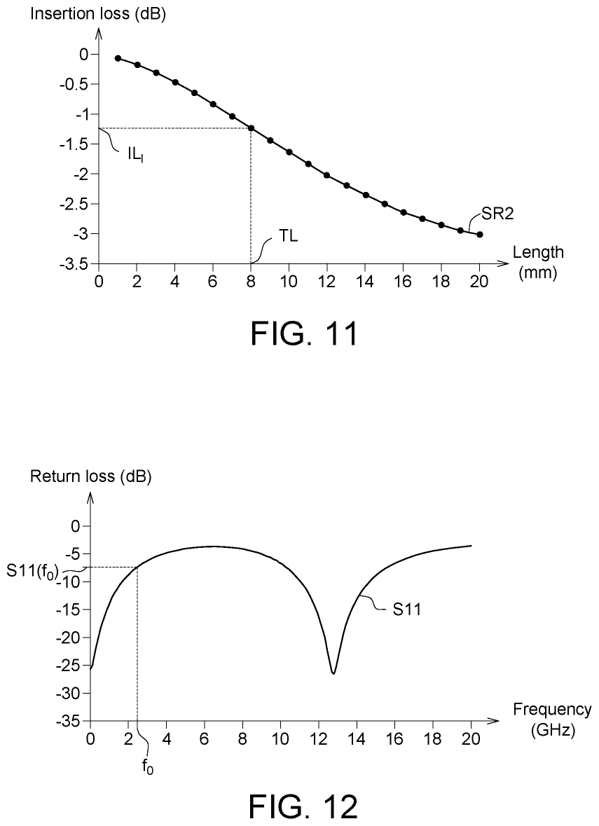

In step S150, referring to FIG. 11, FIG. 11 illustrates a schematic diagram of a corresponding relationship SR2 between a transmission line length and a characteristic parameter IL of the equivalent circuit EC in FIG. 4. The model analysis 110 generates the corresponding relationship SR2 between the transmission line length and the characteristic parameters according to the equivalent circuit EC.

In the present embodiment, the characteristic parameter IL is, for example, “insertion loss”.

For example, the model analysis 110 may obtain the insertion loss IL (voltage amplitude loss) of different numbers n of the equivalent circuits EC connected in series to build the corresponding relationship SR2. The value of n is a positive integer equal to or greater than 1, and the embodiment of the disclosure does not limit the upper limit of n. Taking one (n=1) equivalent circuit EC as an example, the model analysis 110 may obtain the S21 parameter curve of the insertion loss (shown in FIG. 6) of the equivalent circuit EC, and obtain the parameter value (that is, S21 (f₀)) of the S21 parameter curve corresponding to the input frequency f₀ (for example, 2.4 GHZ) from the S21 parameter curve, wherein such parameter value constructs an ordinate of FIG. 11. According to this principle, the model analysis 110 may obtain the characteristic parameter IL of n equivalent circuits EC connected in series (for each additional equivalent circuit EC, one corresponding characteristic parameter IL may be obtained), and build the corresponding relationship SR2 between the transmission line length and the characteristic parameter IL as illustrated in FIG. 11. As illustrated in FIG. 11, the abscissa is the transmission line length of n equivalent circuits EC connected in series, and its unit is millimeters. The ordinate of FIG. 11 is the insertion loss (IL).

In step S160, the model analysis 110 may obtain the transmission line length TL corresponding to a characteristic parameter design target IL_{I} according to the corresponding relationship SR2. For example, as illustrated in FIG. 11, if the characteristic parameter design target IL_{I} (allowable insertion loss) is −1.41 dB, for example, the transmission line length TL corresponding to insertion loss −1.41 dB is 8 mm. In other words, the maximum length of the transmission line on the conductive layer of the design circuit should not exceed 8 mm for preventing the allowable insertion loss of the transmission line from being less than −1.41 dB.

In addition, the model analysis 110 may obtain the characteristic parameter design target IL_{I} by using the following formula (2). In formula (2), Vₒᵤₜ represents the output voltage, and Vᵢₙ represents the input voltage. The input voltage Vᵢₙ is taken as 1 V as an example, the output voltage Vₒᵤₜ is taken as 0.85 V as an example, and accordingly the characteristic parameter design target IL_{I} obtained is −1.41 dB.

$${IL}_{I} = 20 \times log ( \frac{{V}_{out}}{{V}_{in}} ) \qquad ( 2 )$$

In step S170, as illustrated in FIG. 8, after obtaining the transmission line length TL, the 3D model analysis 120 may construct the 3D model M1 of the design circuit (i.e., the 3D semiconductor package structure) according to the obtained transmission line length TL and the layer stackup LS).

In step S180, the electrical simulation 130 determines whether the characteristic parameter IL (insertion loss) of the 3D model M1 meets the characteristic parameter design target IL_{I}. For example, after constructing the 3D model M1, the electrical simulation 130 may analyze the 3D model M1 to obtain the characteristic parameters IL of the 3D model M1 by using the appropriate analysis technology. The aforementioned analysis technology is, for example, electronic design automation, such as EDA software developed by Ansys or Cadence.

If the characteristic parameter IL meets the characteristic parameter design target IL_{I}, the process ends. If the characteristic parameter IL does not meet the characteristic parameter design target IL_{I}, the process proceeds to step S190 to search for another solution from the transmission line model database EM (patent document).

In step S190, the electrical simulation 130 select the patent document that satisfy with “the characteristic parameters of the 3D model M1 meet the characteristic parameter design target IL_{I}” from the patent database PD by using the technology/efficiency/target matrix. The method of obtaining the patent document is similar to that described in FIG. 10 and it will not be repeated here.

In step S192, the 3D model analysis 120 constructs the corresponding 3D model M1. The multi-chip integrated package design method places a structure disclosed in the patent document into the 3D model of the circuit layout. For example, the 3D model analysis 120 updates (or modifies) the 3D model M1 according to the improvement technical solution in the selected patent document.

In step S194, the electrical simulation 130 determines whether the characteristic parameter IL (insertion loss) of the updated (or modified) 3D model M1 meets the characteristic parameter design target IL_{I}. For example, after updating the 3D model M1, the electrical simulation 130 may obtain the characteristic parameter IL of the updated 3D model M1 by using, for example, the aforementioned EDA analysis technology.

If the characteristic parameter IL of the updated 3D model M1 meets the characteristic parameter design target IL_{I}, the process ends. If the characteristic parameter of the updated 3D model M1 does not meet the characteristic parameter design target IL_{I}, the process returns to step S190 to search for another solution from the patented technology again.

The following describes a flow chart of the third package design method of the multi-chip integrated package design system 100. The packaging design method of the present embodiment includes processes similar to that described above. The different steps between the two will be described below, and similar or identical steps will not be repeated here.

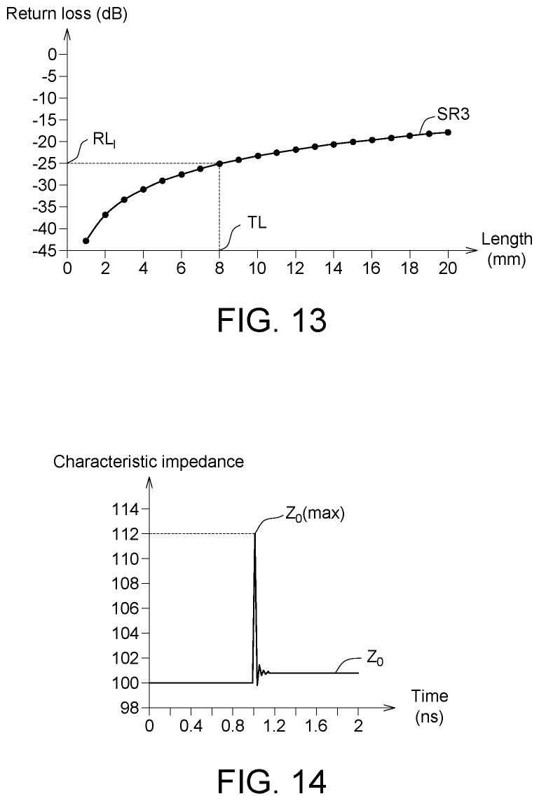

In step S150, referring to FIGS. 12 to 13, FIG. 12 illustrates a schematic diagram of a S11 parameter curve of the return loss of the equivalent circuit EC in FIG. 4, and FIG. 13 illustrates a corresponding relationship SR3 between a transmission line length and a characteristic parameter RL (return loss) of the equivalent circuit EC in FIG. 4. The model analysis 110 generates the corresponding relationship SR3 between the transmission line length and the characteristic parameter according to the equivalent circuit EC.

In the present embodiment, the characteristic parameter RL is, for example, “return loss”.

For example, the model analysis 110 may obtain the return loss of different numbers n of the equivalent circuits EC connected in series to build the corresponding relationship SR3. The value of n is a positive integer equal to or greater than 1. Taking one (n=1) equivalent circuit EC as an example, the model analysis 110 may obtain the S11 parameter curve of the return loss of the equivalent circuit EC (the S11 parameter curve is shown in FIG. 12), and obtain the parameter value (that is, S11 (f₀)) of the S11 parameter curve corresponding to the input frequency f₀ (for example, 2.4 GHZ) from the S11 parameter curve, wherein such parameter value constructs the ordinate of FIG. 13. According to this principle, the model analysis 110 may obtain the characteristic parameter RL (return loss) of n equivalent circuits EC connected in series (for each additional equivalent circuit EC, one corresponding characteristic parameter RL may be obtained), and build the corresponding relationship SR3 between the transmission line length and the characteristic parameter RL as illustrated in FIG. 13. As illustrated in FIG. 13, the abscissa is the transmission line length of n equivalent circuits EC connected in series, and its unit is millimeters. The ordinate of FIG. 13 is the return loss (RL).

In step S160, the model analysis 110 may obtain the transmission line length TL corresponding to a characteristic parameter design target RL_{I} according to the corresponding relationship SR3. For example, as illustrated in FIG. 13, if the characteristic parameter design target RL_{I} (allowable return loss) is −25 dB, for example, the transmission line length TL corresponding to −25 dB is 8 mm. In other words, the maximum length of the transmission line on the conductive layer of the design circuit should not exceed 8 mm for preventing the return loss of the transmission line from being more than −25 dB.

Electrical simulation 130 may obtain the characteristic parameter RL (return loss) by using use the following formulas (3A) to (3C). In the formula, Z_{O} represents the characteristic impedance of the signal source (for example, component A), Z_{L} represents the characteristic impedance of the transmission line, Γ represents the reflection coefficient, and ΔZo represents the design allowable error.

$$RL = - 20 \times log \vert Γ \vert \qquad ( 3 A )$$

$$Γ = ( {Z}_{L} - {Z}_{O} ) / ( {Z}_{L} + {Z}_{O} ) \qquad ( 3 B )$$

$${Z}_{L} = Zo \pm Δ Zo \qquad ( 3 C )$$

Taking the signal source characteristic impedance Z_{O} as 50 ohms (Ω) and the design allowable error ΔZo as 5% as an example, the calculated characteristic parameter RL (return loss) ranges between −32.3 dB and −35.3 dB.

In step S170, as illustrated in FIG. 8, after obtaining the transmission line length TL, the 3D model analysis 120 may construct the 3D model M1 of the design circuit (i.e., the 3D semiconductor package structure) according to the obtained transmission line length TL and the layer stackup LS).

In step S180, the electrical simulation 130 determines whether the characteristic parameter Zo (characteristic impedance) of the 3D model M1 satisfy within the range of the characteristic parameter design target Z_{O}±ΔZo. For example, after constructing the 3D model M1, the electrical simulation 130 may analyze the 3D model M1 to obtain the characteristic parameters Z_{O} of the 3D model M1 by using appropriate analysis technique. The aforementioned analysis technology is, for example, electronic design automation, such as EDA software developed by Ansys or Cadence.

Referring to FIG. 14, FIG. 14 illustrates a schematic diagram of the characteristic parameter of the 3D model M1 in FIG. 8. It may be seen from the FIG. 14 that the maximum characteristic parameter Zo(max) (11202) of the 3D model M1 is greater than 110Ω. That is, the characteristic parameter Zo exceeds the range of the characteristic parameter design target Z_{O}±ΔZo (90Ω to 110Ω). The characteristic parameter design target Zo of one transmission line is 50Ω. There are two transmission lines in the embodiment of the disclosure, and thus the characteristic parameter design target Zo of a pair of transmission lines is 100Ω. Considering the allowable error of 10%, the characteristic parameter design target Zo is between 90 Ω to 110Ω.

If the characteristic parameter Zo (characteristic impedance) satisfy within the range of the characteristic parameter design target Z_{O}±10%, the process ends. If the characteristic parameter Zo (characteristic impedance) exceeds the range of the characteristic parameter design target Z_{O}±10%, the process proceeds to step S190 to search for another solution from the transmission line model database EM (patent document).

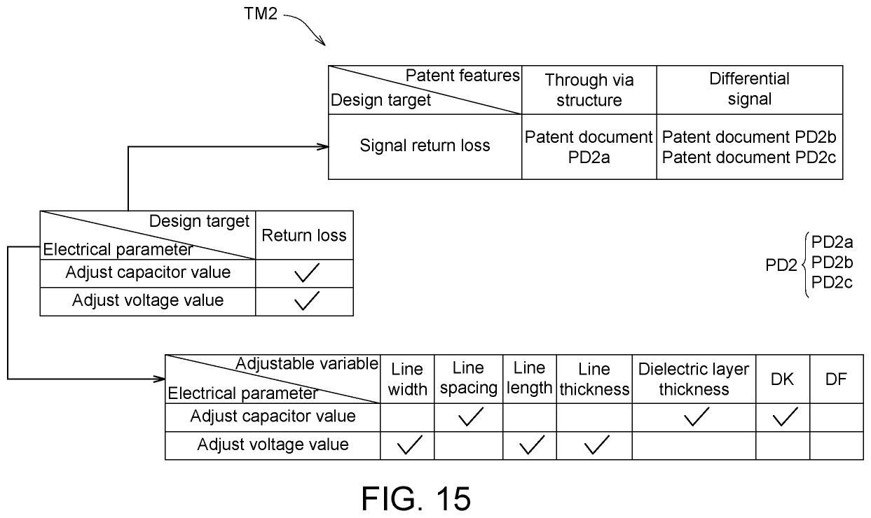

In step S190, referring to FIG. 15, FIG. 15 illustrates a schematic diagram of the technology/efficiency/target matrix TM2 according to another embodiment of the disclosure. Electrical simulation 130 may select the patent document from the patent database PD that may satisfy with “the characteristic parameter Zo (characteristic impedance) of the 3D model M1 meets to being within the range of the characteristic parameter design target Z_{O}±ΔZo” by using the technology/efficiency/target matrix TM2.

For example, as illustrated in FIG. 15, the technology/efficiency/target matrix TM2 lists the relationships among technology, efficacy, design target and corresponding patent documents (for example, the patent number). it may be seen from the technology/efficiency/target matrix TM2 that the reduction of return loss is related to the adjustment of the capacitance value and the inductance value, wherein the capacitance value is related to the transmission line spacing, the thickness and the dielectric constant (DK) of the dielectric layer, and the inductance value is related to the width, the length and the thickness of the transmission line. The patent document related to these information is the patent document PD2a. According to the content of the patent document PD2a, the ground island structure may be used to satisfy with “the characteristic parameter Zo(max) of the 3D model M1 meets to being within the range of the characteristic parameter design target Z_{O}±ΔZo”.

In step S192, referring to FIG. 16, FIG. 16 illustrates a part of the top view of the improved 3D model M1 in FIG. 8. The 3D model analysis 120 constructs the corresponding 3D model M1. The multi-chip integrated package design method places a structure disclosed in the patent document into the 3D model of the circuit layout. For example, the 3D model analysis 120 places an improved structure of the ground island structure M1G into the previous 3D model M1.

In step S194, the electrical simulation 130 determines whether the characteristic parameter Zo (characteristic impedance) of the updated (or modified) 3D model M1 satisfy within the range of the characteristic parameter design target Z_{O}±ΔZo. For example, after updating the 3D model M1, the electrical simulation 130 may obtain the maximum characteristic impedance Zo(max) of the updated 3D model M1 by using, for example, EDA analysis technology.

If the characteristic parameter Zo of the updated (or modified) 3D model M1 is within the range of the characteristic parameter design target Z_{O}±ΔZo, the process ends. If the characteristic parameter Zo of the updated 3D model M1 exceeds the range of the characteristic parameter design target Z_{O}±ΔZo, the process returns to step S190 to search for another solution from the patented technology again.

It will be apparent to those skilled in the art that various modifications and variations could be made to the disclosed embodiments. It is intended that the specification and examples be considered as exemplars, with a true scope of the disclosure being indicated by the following claims and their equivalents.

What is claimed is:

1. A multi-chip integrated package design method, comprising:
obtaining a schematic of a design circuit;
performing a circuit layout according to the schematic of the design circuit;
constructing a three-dimensional (3D) model of the circuit layout;
determining whether a characteristic parameter of the 3D model meets a characteristic parameter design target;
select a patent document that meets the circuit layout from a patent database when the characteristic parameter does not meet the characteristic parameter design target; and
optimizing the design circuit according to the patent document;
wherein performing the circuit layout according to the schematic of the design circuit comprises:
obtaining a pin connection mode of the design circuit according to the schematic of the design circuit;
obtaining at least one conductive layer of the design circuit according to the layer stackup;
selecting a transmission line model that meets the pin connection mode and the at least one conductive layer from a plurality of the transmission line models in a transmission line model database;
generating an equivalent circuit by substituting the layer stackup and a design rule into the selected transmission line model;
generating a corresponding relationship between a transmission line length and the characteristic parameter according to the equivalent circuit;
obtaining the transmission line length corresponding to the characteristic parameter design target according to the corresponding relationship of the transmission line length and the characteristic parameter, wherein the transmission line length is used as a design constraint for the circuit layout; and
wherein constructing the 3D model of the circuit layout comprises:
performing the circuit layout of the design circuit according to the obtained the transmission line length used as the design constraint and construct the 3D model of the circuit layout.

2. The multi-chip integrated package design method according to claim 1, wherein selecting the patent document that meets the circuit layout from the patent database when the characteristic parameter does not meet the characteristic parameter design target comprises:
when the characteristic parameter does not meet the characteristic parameter design target, selecting the patent document that meets the circuit layout from the patent database by using a technology/efficiency/target matrix and placing a structure disclosed in the patent document into the 3D model of the circuit layout.

3. The multi-chip integrated package design method according to claim 1, wherein the characteristic parameter VL is a voltage amplitude loss; the multi-chip integrated package design method further comprises:
comprising the voltage amplitude loss according to following formula (1);
$$VL = {10}^{\frac{S 21 ( {f}_{0} )}{20}} ; \qquad ( 1 )$$
wherein f₀ represents an input signal frequency, and S21 represents an insertion loss of a S parameter.

4. The multi-chip integrated package design method according to claim 3, further comprises:
obtaining the voltage amplitude losses of different numbers of the equivalent circuits connected in series to build a corresponding relationship between a transmission line length and the voltage amplitude loss.

5. The multi-chip integrated package design method according to claim 1, wherein the characteristic parameter is an insertion loss; the multi-chip integrated package design method further comprising:
obtaining the characteristic parameter design target IL_{I} according to following formula (2);
$${IL}_{I} = 20 \times log ( \frac{{V}_{out}}{{V}_{in}} ) \qquad ( 2 )$$
wherein Vₒᵤₜ represents an output voltage, and Vᵢₙ represents an input voltage.

6. The multi-chip integrated package design method according to claim 5, further comprising:
obtaining the insertion losses of different numbers of the equivalent circuits connected in series to build a corresponding relationship between the transmission line length and the insertion loss.

7. The multi-chip integrated package design method according to claim 5, wherein the characteristic parameter is a return loss; the multi-chip integrated package design method further comprising:
obtaining the characteristic parameter design target RL according to following formula;
$$RL = - 20 \times log \vert Γ \vert$$
wherein a reflection coefficient Γ=(Z_{L}−Z_{O})/(Z_{L}+Z_{O}), wherein Z_{L} represents a characteristic impedance of the transmission line, and Z_{O} represents a characteristic impedance of a signal source.

8. The multi-chip integrated package design method according to claim 7, further comprising:
obtaining the return loss of different numbers of the equivalent circuits connected in series to build a corresponding relationship between the transmission line length and the return loss.

9. A multi-chip integrated packaging design system, comprising:
a model analysis configured to:
obtain a schematic of a design circuit; and
perform a circuit layout according to the schematic of the design circuit;
a 3D model analysis configured to:
construct a 3D model of the circuit layout;
an electrical simulation configured to:
determine whether a characteristic parameter of the 3D model meets a characteristic parameter design target;
select a patent document that meets the circuit layout from a patent database when the characteristic parameter does not meet the characteristic parameter design target; and
optimize the design circuit according to the patent document;
wherein the model analysis is further configured to:
obtain a pin connection mode of the design circuit according to the schematic of the design circuit;
obtain at least one conductive layer of the design circuit according to the layer stackup;
select a transmission line model that meets the pin connection mode and the at least one conductive layer from a plurality of the transmission line models in a transmission line model database;
generate an equivalent circuit by substitute the layer stackup and a design rule into the selected transmission line model;
generate a corresponding relationship between a transmission line length and the characteristic parameter according to the equivalent circuit; and
obtain the transmission line length corresponding to the characteristic parameter design target according to the corresponding relationship between the transmission line length and the characteristic parameter, wherein the transmission line length is used as a design constraint for the circuit layout;
wherein the 3D model analysis is further configured to:
perform the circuit layout of the design circuit according to the obtained the transmission line length used as the design constraint and construct the 3D model of the circuit layout.

10. The multi-chip integrated packaging design system according to claim 9, wherein the electrical simulation is further configured to:
when the characteristic parameter does not meet the characteristic parameter design target, select the patent document that meets the circuit layout from the patent database by using a technology/efficiency/target matrix and place a structure disclosed in the patent document into the 3D model of the circuit layout.

11. The multi-chip integrated packaging design system according to claim 9, wherein the characteristic parameter VL is a voltage amplitude loss; the model analysis is further configured to:
obtain the voltage amplitude loss according to following formula (1);
$$VL = {10}^{\frac{{S}_{21} ( {f}_{0} )}{20}} ; \qquad ( 1 )$$
wherein f₀ represents an input signal frequency, and S21 represents an insertion loss of a S parameter.

12. The multi-chip integrated packaging design system according to claim 11, wherein the model analysis is further configured to:
obtain the voltage amplitude losses of different numbers of the equivalent circuits connected in series to build a corresponding relationship between the transmission line length and the voltage amplitude loss.

13. The multi-chip integrated packaging design system according to claim 9, wherein the characteristic parameter is an insertion loss; the model analysis is further configured to:
obtain the characteristic parameter design target IL_{I} is according to following formula (2);
$${IL}_{I} = 20 \times log ( \frac{{V}_{out}}{{V}_{in}} ) \qquad ( 2 )$$
wherein Vₒᵤₜ represents an output voltage, and Vᵢₙ represents an input voltage.

14. The multi-chip integrated packaging design system according to claim 13, wherein the model analysis is further configured to:
obtain the insertion losses of different numbers of the equivalent circuits connected in series to build a corresponding relationship between the transmission line length and the insertion loss.

15. The multi-chip integrated package design system according to claim 9, wherein the characteristic parameter is a return loss; the model analysis is further configured to:
obtain the characteristic parameter design target RL according to following formula;
$$RL = - 20 \times log \vert Γ \vert ;$$
wherein a reflection coefficient γ=(Z_{L}−Z_{O})/(Z_{L}+Z_{O}), wherein Z_{L} represents a characteristic impedance of the transmission line, and Z_{O} represents a characteristic impedance of a signal source.

16. The multi-chip integrated package design system according to claim 15, wherein the model analysis is further configured to:
obtain the insertion losses of different numbers of the equivalent circuits connected in series to build a corresponding relationship between the transmission line length and the return loss.
